(19) United States
(12) Patent Application Publication
(10) Pub. No.: US 2026/0228690 A1
(43) Pub. Date: Aug. 6, 2026

(54) SYSTEM FOR YARD CHECK-IN AND CHECK-OUT

(71) Applicant: KoiReader Technologies, Inc., Coppell, TX (US)

(72) Inventors: Ashutosh Prasad, Coppell, TX (US); Vivek Prasad, Bengaluru (IN)

(21) Appl. No.: 19/637,146

(22) Filed: Apr. 2, 2026

Related U.S. Application Data
(63) Continuation of application No. 19/101,010, filed on Aug. 3, 2023.
(60) Provisional application No. 63/370,414, filed on Aug. 4, 2022.

(51) Int. Cl. G06Q 10/087; G06V 10/82; G06V 20/52; G07C 9/10

(52) U.S. Cl. CPC G06Q 10/08772; G06V 10/82; G06V 20/52; G07C 9/10; G06V 2201/08

(57) ABSTRACT

Techniques are described for automating the check in and check out and inspection process at a logistics facility. For example, a system may be configured to capture sensor data associated with an approaching vehicle. The sensor system may utilize the sensor data to extract information usable to complete forms, assess damage, and authenticate the shipment.

### CROSS-REFERENCE TO RELATED APPLICATION(S)

This application is a continuation of and claims priority to U.S. application Ser. No. 19/101,010, filed on Feb. 4, 2025 and entitled “SYSTEM FOR YARD CHECK-IN AND CHECK-OUT,” which is a U.S. national stage application under 35 USC § 371 of International Application No. PCT/US23/29420 filed on Aug. 3, 2023 which claims priority to U.S. Provisional Application No. 63/370,414 filed on Aug. 4, 2022, the entire contents of which are incorporated herein by reference.

### BACKGROUND

Storage facilities, yards, shipping centers, processing plants, warehouses, distribution centers, cross docks, ports, and the like, may receive, store, and ship vast quantities of inventory over a period of time. However, all of the inventory coming into and leaving the facility as well as the delivery vehicles are checked-in and checked-out upon entry and exit of the facility. The check-in and check-out process may be a time consuming manual process requiring specially trained facility operators to review the often complex documentation. Logistical delays often happen at the entry and exit locations of a facility as a result of a single vehicle or document issue.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example pictorial diagram of a vehicle being processed by a verification system associated with a facility, according to some implementations.

FIG. 2 is an example block diagram of a verification system including sensor system 202 associated with a facility for performing check ins and check outs, according to some implementations.

FIG. 3 is a flow diagram illustrating an example process associated with a verification system at a facility, according to some implementations.

FIG. 4 is another flow diagram illustrating an example process associated with a verification system at a facility, according to some implementations.

FIG. 5 is an example system that may implement the techniques described herein according to some implementations.

FIG. 6 is an example pictorial view associated with the systems of FIGS. 1-5 according to some implementations.

FIG. 7 is another example pictorial view associated with the systems of FIGS. 1-5 according to some implementations.

FIG. 8 is another example pictorial view associated with the systems of FIGS. 1-5 according to some implementations.

FIG. 9 is an example diagram associated with the systems of FIGS. 1-5 according to some implementations.

### DETAILED DESCRIPTION

Discussed herein is a system for monitoring, tracking, and checking-in and checking-out vehicles, drivers, and assets from a facility. In some examples, the facility may include a controlled check-in area and check-out area, such as a gated entry with or without a self-serve kiosk, smart tablet, other personal electronic device, or the like. The system may also include a waiting area, a loading/unloading area (such as a dock door), and, in some cases, an additional inventory inspection or secondary check-in area. In the system discussed herein, the facility may be equipped with image devices (such as EDGE computing devices, cameras, scanners, other sensors, and the like) to capture and/or generate data associated with the vehicle as the vehicle enters the facility, undergoes inspection, is unloaded, reloaded, and exits the facility. The system may also include a verification system to receive the captured data from the sensor or image systems at various locations throughout the facility.

The verification system may be configured to utilize the captured data to authenticate vehicle and/or driver credentials, check-in vehicles, perform vehicle or inventory inspections, confirm transfer of assets to and from the vehicle (e.g., via loading and unloading), and to subsequently check-out the vehicle. In this manner discussed herein, the system may reduce the amount of time associated with checking in and/or out each vehicle, asset, container, and the like as the vehicle enters and exits a facility. For example, conventional manual check out processes at a logistics facility typically take between 30 and 45 minutes per vehicle and, in some case, may take as long several hours per vehicle. In some instances, such as during peak shipping seasons, the long check in and out process may also result in long lines which add further delays, as the vehicles and drivers wait in line at appropriate entry and exit points. For example, the check-in and check-out process may be a time consuming manual process requiring specially trained facility operators to review the often complex documentation that includes open yard space allocation for trailers or dock appointment adjustments due to supply chain issues.

Alternatively, the system, described herein, may reduce the overall check in and out times to just few seconds or less, thereby reducing the congestion at the exit and entry points and allowing the vehicles and drivers to spend more time transporting goods and less time waiting and completing forms.

Additionally, surcharges related to dwell time, demurrage, detention, or environmental regulation compliance related to engine idle time may not be properly measured and audited in conventional systems for lack of yard entry and exit audit trails and other records. Some facilities may also require DHS threat and safety compliance checks or trailer damages for claims management. Tire safety detection and driver HOS at the time of yard exit are other important factors to meet FMCSA compliance and DOT fines related to highway safety compliance. The expansion of last mile delivery solutions to consumers and stores using uberized fleet is another category besides trucks that needs to be monitored, managed, and audited at point of entry and exit.

In some cases, lack of multi-lingual staff and tools at entry and exit points leads to driver communication related delays for supply chains. Often, drivers or transport operators leave yards without picking an empty or loaded trailer (e.g., bobtailing) or the yard jockeys leave the yard for an extended duration with a yard mule which is undesirable for supply chains from a traffic and operations management perspective. In some cases, the inventory being brought into a yard are imported vehicles that need to be checked in and monitored from the time of entry to exit for insurance claims purposes. All of this interaction happens at the entry and exit yard gate in global supply chains.

Accordingly, the system, discussed herein, may provide supply chains needed near or substantially real-time capture of a combination of following information at the time of entry and/or exit of a facility, directly through automated capture or indirectly through data correlation and augmentation, depending on the type of supply chain: DOT number, MC Number, Carrier Name, BOL Number, Driver Trip ID, Driver's License ID, Tractor/Trailer/Chassis/Vehicle License Plate Number, Presence of a Trailer Seal, Trailer Seal Number, Entry and Exit Time Video and/or Image Audit Trail, HAZMAT / Dangerous Goods Markings, Vehicle Damage, Tire Safety Compliance, Assigned Driver Verification, Driver HOS (Hours of Service) Compliance, Environmental Regulation Compliance (Engine Idle Time at Check-in as an example), Shipment ID, Virtual Vehicle ID in case of vehicle import/export operations where no license plate number exists, and other similar attributes. This captured data often needs to be complemented with other supply chain data such as Open Yard Slot for Tractor/Trailer/Chassis Parking and Predictive Dock Door Appointment from supply chain systems and yard operations to minimize check-in and check-out times at Yard Gates as well as eliminate unplanned fines, penalties, and claims. In some cases, a driver may also return a leased asset, empty pallets or a leased vehicle or a leased equipment, at or within the yard gate in a designated area that may require automatic capture and verification in an unsupervised or supervised manner for count and conditions against the checked-out asset.

For instance, in some implementations, the system discussed herein, may be configured to capture image data associated with vehicle credentials as well other documents (such as a bill of lading, driver's license, customs documents, and the like) scanned or presented by drivers or vehicle operators at the check-in area, check-out area, inspection area, loading areas, and the like. In some cases, the systems may include an electronic system, such as a Kiosk, handheld device, camera or video systems, and the like. The system may extract credential information from the captured sensor and/or image data. The extracted credential information may then be used to verify entry (e.g., the driver and vehicle is authorized and/or expected), complete required forms (e.g., government forms, custody forms, liability forms, and the like), and notify various entities that delivery tasks are completed, delayed, planned (e.g., planned unloading), current status (e.g., based on real time available data, such as image data at an unloading or loading area, or open parking slots in the yard), and/or on schedule. For example, the captured information may be utilized to identify an incoming shipment of trailers and/or containers, complete customs forms, and transfer custody or delivery of containers or create an electronic proof of delivery of trailers, containers, assets, and/or any goods associated therewith.

As an illustrative example, a vehicle may approach the check-in area of a facility. As the vehicle approaches, the sensor systems may capture sensor data representative of the vehicle as well as vehicle credential information, such as vehicle identification numbers (VIN), USDOT Number, Motor Carrier (MC) number, country flags or identifiers, interannual code of signals (ICS) identifiers, craft identification numbers (CIN), governmental register numbers (such as naval registry numbers, license plates, and the like), vehicle name, vehicle classification symbols or numbers, global shipment identification numbers (GSIN), container identifiers, chassis identifiers, hazardous symbols, tracking number, chassis number, and the like.

The verification system may determine a vehicle type (such as delivery van, semitruck, autonomous truck, ship class, rail car or train class, and the like). The system may then determine the expected vehicle credential information based on the vehicle type and/or expected delivery during a current period of time. The verification system may parse the sensor data to locate and identify the expected vehicle credential information. In some cases, if the vehicle credential information matches an expected vehicle or delivery, the system may allow the vehicle entry into the facility (e.g., cause the gate or door to open).

In some cases, the system may also scan a biometric (such as a thumb print, facial scan, eye scan, or the like) associated with a driver or operator of the vehicle to determine the operator is also expected. In some examples, the system may allow a user, such as the driver or operator, to scan the biometric data or otherwise authenticate with the system using a personal electronic device. For instance, the personal electronic device may be configured or equipped with a downloadable application that may capture authentication data (e.g., biometric data, passwords, and the like) and communicate the authentication data to a cloud-based system that may complete the driver or operator authentication process.

In some cases, upon entry into the facility, the vehicle may proceed to an inspection area to provide additional paperwork, receive additional authorizations, and to confirm contents of the vehicle (e.g., assets). In this example, the driver or operator of the vehicle may provide, display, or otherwise show required documents to a scanning system. In some cases, the driver may place or make visible each document and/or page, such that a scanning, sensor, and/or image system may capture data associated with the presented page. For example, the driver may hold each page up to a window of the vehicle to allow for contactless scanning of the documents. In some cases, a smart tablet, handheld electronic device, or device may be used to capture Seal ID from the trailer/container and augment the sensor captured data.

The system may also employ an automated aerial vehicle or other sensor system that may allow the facility to scan the contents of the vehicle or containers. In some case, the driver or operator of the vehicle may assist via automated voice commands or instructions (including, in some instances, multi-lingual voice commands or computer generated, translated, or otherwise processed voice commands) displayed on a display at the inspection area to select a package or container for opening such that the scanning, sensor, and/or image system may capture data associated with the contents (e.g., assets) of the container. In this example, the inspection area may be unitized to improve the flow of vehicles into the facility, however, it should be understood that the documents may be processed at the entry location, an intermediate area, and/or at an unloading area.

The system may parse the captured sensor data to extract information associated with the documents, such as using optical character recognition techniques, confirm the assets and a condition of the assets, accept a chain of custody for the assets, and the like. The system may also confirm the extracted data is correct and complete. If the extracted data is not, the system may attempt to obtain the correct and/or missing information from a third party, such as a system associated with the vehicle, the seller, the buyer, a government agency, other facility, or the like. By obtaining the information directly from another system, the verification system, discussed herein, may reduce the overall wait time and delay caused by incorrectly completed forms and documents typical with conventional check-in systems.

Once the documents are accepted by the system, the vehicle may be directed to a waiting area and/or an unloading area. At the unloading area, the system may include additional sensor and/or image devices to track the assets as they are unloaded from the vehicle. The assets may then be assigned by the system to storage areas, repackaging areas, or other loading areas. In some cases, the system may confirm the number, type, and state (e.g., condition) of the assets as they are unloaded from the vehicle.

In some examples, the system may be configured to process the sensor data to identify damage or other issues associated with an asset, container, THU, or the like. For example, an asset may have damage, be opened, or otherwise have concerns that may not become apparent until the assets are unloaded. Thus, in some cases, the system may inspect each asset as the asset is unloaded from the vehicle. In some cases, the system may also detect damage to the exterior of the containers or vehicle as the vehicles are checked in and/or exit the facility. In this manner, the system may be able to estimate if damage may include damage to assets contained within the containers or vehicles (such as via a machine learned model trained on container and vehicle damage data). The system may also be configured to alert or otherwise notify the third-party system, facility system, operators, managers, insurance carriers, government agencies, and the like in response to detecting damage. In some cases, the system may also time stamp the detection and/or compare sensor data with data collected at the originating facility (such as when unloading a vehicle or container) to determine a time and/or responsible party for the damage.

In some cases, after unloading the vehicle may be loaded with new assets. The system may again track the number, type, and status of the assets as they are loaded onto the vehicle via the data captured the sensors and/or image devices. The system may again transfer the chain of title or custody from the facility to the vehicle or an entity associated with the vehicle.

The vehicle may then proceed to the exit or check-out area in which the vehicle information may again be scanned or data captured by the sensor and/or image system. In some cases, the system may again determine the type of vehicle and, based on the type, determine expected vehicle information. The system may then extract the expected information to perform the vehicle check-out. The system may again collect biometric data associated with driver or operator of the vehicle to again confirm the correct vehicle and operator are exiting the facility and accepting a chain of title or custody for the assets. In some cases, the chain of title may be updated via a block chain enabled code or system. In some cases, the system may provide for unsupervised or supervised asset return (e.g., return to sender) or rejection of a portion of the assets opposed to a complete rejection or denial of entry to the facility. In some cases, the system may determine a value associated with the assets being returned and/or a number of assets being returned to the originating facility. In these cases, the system may cause a credit or refund for the receiving facility for the returned or otherwise rejected portion of the assets from a particular delivery.

In some examples discussed herein, the sensors and/or image devices may be internet of things (IoT) computing devices that may be equipped with various sensors and/or image capture technologies, and configured to capture, parse, and identify vehicle and container information from the exterior of vehicles, containers, pallets, and the like. The vehicle and container information may include shipping documents, such as BOL (Bill of Lading), packing list, container identifiers, chassis identifiers, vehicle identifiers, and the like. The IoT computing devices may also capture, parse, and identify driver information in various formats, such as driver licenses, driver's identification papers, facial features and recognition, and the like. In some cases, the optical character recognition techniques may be performed without model training and/or machine learned models, while in other cases, the optical character recognition techniques may utilize one or more machine learned models and/or networks.

As discussed above, the system may include multiple IoT devices at various locations as well as cloud-based services, such as cloud based data processing. One or more IoT computing device(s) may be installed at entry and/or exit points of a facility. The IoT computing devices may include a smart network video recorder (NVR) or other type of EDGE computing device. Each IoT device may also be equipped with sensors and/or image capture devices usable at night or during the day. The sensors may be weather agnostic (e.g., may operate in foggy, rainy, or snowy conditions), such as via infrared image systems, radar based image systems, LIDAR based image systems, SWIR based image systems, Muon based image systems, radio wave based image systems, and/or the like. The IoT computing devices and/or the cloud-based services may also be equipped with models and instructions to capture, parse, identify, and extract information from the vehicles, containers, and/or various documents associated with the logistics and shipping industry. For example, the IoT EDGE computing devices and/or the cloud-based services may be configured to perform segmentation, classification, attribute detection, recognition, document data extraction, optical character recognition and the like. In some cases, the IoT computing devices and/or an associated cloud based service may utilize machine learning and/or deep learning models to perform the various tasks and operations.

In some cases, since the sensor and/or image data received may be from different sources or types of sensors at different ranges and generalities, the IoT computing devices may perform a data normalization using techniques such as threshold-based data normalization and machine learning algorithms to identify the driver, vehicle, or container. It should be understood that the system may utilize different weighted averages or thresholds based on the data source (e.g., sensor type, location, distance, and position), the current weather (e.g., sunny, rainy, snowy, or foggy), and time of day when performing data normalization. In some cases, given information may be present at one or more side or surface of the assets, vehicles, and/or containers, as the assets, vehicles, and containers moves through the monitored area, view from multiple cameras is merged with the help of one or more birds-eye view camera to get a holistic view of the asset from multiple angles. They system may then extracts the information from these images/video feeds and associates it to the asset uniquely using the perspective from the birds-eye view camera. In some cases, machine learning algorithms may also be applied to remove the distortion from images caused by rain, dust, sand, fog, and the like as well as to brighten the sensor and/or images shot in low-light or dark conditions.

In some cases, a confidence score may be utilized through scanning of various attributes from multiple sensors to determine the accuracy of the data captured or generated under sub-optimal conditions (e.g., rust on trailers or license plates that may render one or more alphanumeric character unreadable). In some cases, the system may verify against a checksum for accuracy determination based on the nomenclature followed in a particular region or a country for unique asset identification number (such as a DOT number, MC number, License Plate Number, Bar Code, etc.). In some cases, crowd logic may be used to determine the accuracy of a captured attribute from multiple sensor sources scanning the asset from one or multiple views. In some cases, the carrier (e.g., entity associated with a transport vehicle) name, a carrier identifier, may not clearly distinguishable on an asset, and a captured attribute such as License Plate Number may be used to perform a reverse lookup against a DMV or FMCSA database to determine the carrier name and/or other identifier, such as an ID.

As described herein, the machine learned models may be generated using various machine learning techniques. For example, the models may be generated using one or more neural network(s). A neural network may be a biologically inspired algorithm or technique which passes input data (e.g., image and sensor data captured by the IoT computing devices) through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model in the form of semantic per-pixel classifications (e.g., vehicle identifier, container identifier, driver identifier, and the like).

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3(ID3 ), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, ResNeXt, VGG, DenseNet, PointNet, ViT and the like. In some cases, the system may also apply

Gaussian blurs, Bayes Functions, color analyzing or processing techniques and/or a combination thereof.

In some implementations, the IoT computing devices may also be configured to estimate one or more statuses of the contents of the containers, crates, and the like as the vehicles enter and exit the facility. For example, the IoT computing devices may use various types of a sensors (e.g., LIDAR, SWIR, Radio Wave, Muon, etc.), with capabilities such as but not limited to varying fields of view, along with the camera or image systems and edge computing capabilities to detect various attributes such as container damage, leakage, size, weight, and the like of a vehicle, chassis, and/or container. In this manner, the IoT computing devices may operate as part of a network, IoT, colocation, Wi-Fi, local-zones, Bluetooth Low Energy, LoRaWAN or the like to provide a comprehensive diagnostic of the physical attributes of a vehicle, truck, trailer, chassis, rail car, cargo, ship, and/or container during entry and exit of the facility. In some cases, the IoT computing devices and/or the cloud based services may be used to identify vehicles, chassis, and/or container that require maintenance prior to further deployment. In some cases, the sensor system may also use a “GeoFence” (e.g., based at least in part on Global Position Satellite coordinates) to interface with an electronic logging device (ELD) device or another IoT device (e.g., temperature and humidity tracking sensor) or a Smart Phone Application installed in the asset entering or exiting a facility to augment the data capture to complete the yard check-in process.

In some cases, the system may also include one or more autonomous vehicles, e.g., an autonomous ground vehicle (AGV) or an autonomous aerial vehicle (AAV), or drones that are arranged throughout the facility (e.g., the warehouse or yard) such that the AVGs and/or AAVs may rotate between charging and performing data capture activities, such as inspecting vehicles and/or assets. In some cases, the AVGs and/or AAVs may be equipped with at least one forward facing image capture device for capturing image data usable for navigation and path planning and at least one downward facing image capture device associated with capturing images of inventory within the facility. In some cases, the AVGs and/or AAVs may be configured for indoor navigation via a simultaneous localization and mapping (SLAM) technique or a visual simultaneous localization and mapping (VSLAM) technique. Thus, the AVGs and/or AAVs may operate without receiving or detecting a satellite signal, such as a Global Positioning System (GPS) or Global Navigation Satellite System (GNSS) signal. In some cases, the AVGs and/or AAVs may be small, such as less than 6 inches, less than 8 inches, or less than 12 inches in height so that the AVGs and/or AAVs may travel between rows of a rack or storage system within the facility without crashing. In some cases, the charging stations may be configured to supercharge the batteries or power supplies of the AVGs and/or AAVs, such that a complete charge may be obtained within 20-30 minutes and provide between 5 and 20 minutes of flight time.

In some cases, the verification system may also include a central processing system or server that is in wireless communication with each of the IoT devices and/or AVGs and/or AAVs, and is configured to process the captured data, as discussed herein. The central processing system may be configured to receive image data and operational data from the AVGs and/or AAVs, charging stations, static image capture devices, and other processing equipment. The central processing system may process the image data using various techniques, such as a machine learned models, to determine inventory counts, quality, status, etc. associated with the inventory within the facility. In some cases, the central processing system may determine locations or cause the processing equipment or an operator of the processing equipment to access the inventory at the location for further processing.

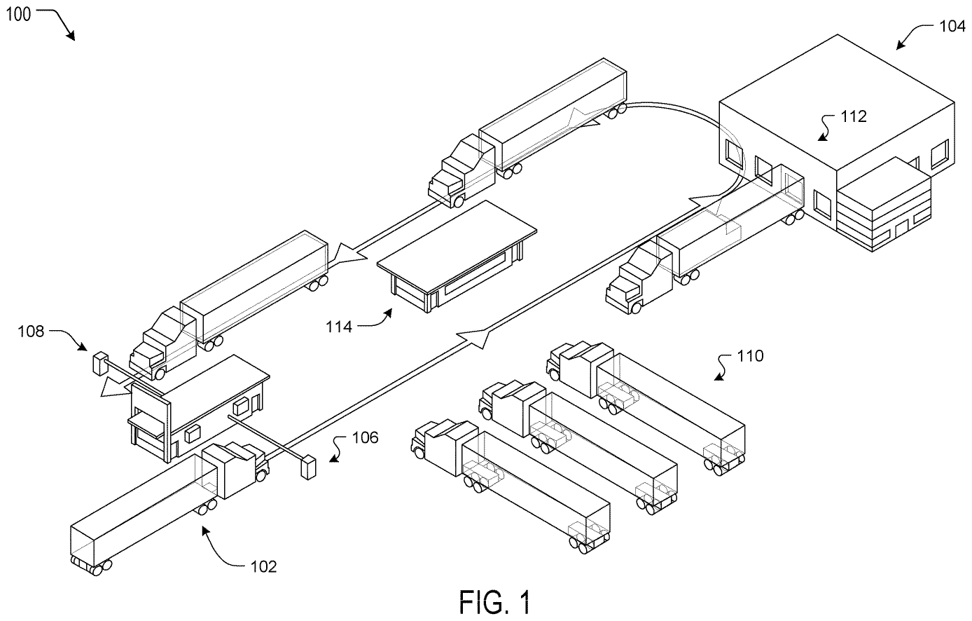

FIG. 1 is an example pictorial diagram 100 of a vehicle 102 being processed by a verification system associated with a facility 104, according to some implementations. In the current example, a vehicle facility 104 may also include check-in or entry area 106, a check-out or exit area 108, a waiting area 110, a loading/unloading area 112 (such as a dock door), and, in some cases, an additional inventory inspection or secondary check-in area 114. As discussed above, the areas 106-114 of the facility 104 may be equipped with sensors and/or image devices to capture and/or generate data associated with the vehicle as the vehicle 102 enters the facility, undergoes inspection, is unloaded, reloaded, and exits the facility 104.

The verification system may be configured to utilize the captured data to authenticate vehicle credentials, check-in the vehicle 102, perform vehicle or inventory inspections, confirm transfer of assets to and from the vehicle 102 (e.g., via loading and unloading), and to subsequently check-out the vehicle 102. In this manner discussed herein, the system may reduce the amount of time associated with checking in and/or out each vehicle 102, container, and the like as the vehicle enters and exits a facility 104.

The system discussed herein, may be configured to capture image data associated with vehicle credentials (e.g., carrier identifiers, motor carrier identifiers, vehicle identification numbers, license plate number, chassis number, carrier name, authorizing state and country, and the like) as well other documents (e.g., inventories, asset lists, customs forms, contracts, legal documents, vehicle documents, operator documents, originating facility documents, and the like) scanned or presented by drivers or vehicle operators at the check-in area, check-out area, inspection area, loading areas, and the like. The system may then extract credential information from the captured sensor and/or image data. The extracted credential information may then be used to verify entry (e.g., the driver and vehicle is authorized and/or expected), complete required forms (e.g., government forms, custody forms, liability forms, and the like), and notify various entities (e.g., originating entity, receiving entity, government agencies or bodies, shipping entities, owners, customers, and the like) that delivery tasks are completed, delayed, and/or on schedule. For example, the captured information may be utilized to identify an incoming shipment of containers, complete customs forms, and transfer custody or delivery of container and any goods associated therewith.

As an illustrative example, a vehicle 102 may approach the check-in 106 area of a facility 104. As the vehicle 102 approaches, the sensor systems may capture sensor data representative of the vehicle 102 as well as vehicle credential information. The verification system may determine a vehicle type (such as delivery van, semitruck, ship class, rail car or train class, and the like). The system may then determine the expected vehicle credential information based on the vehicle type and/or expected delivery during a current period of time. The verification system may parse the sensor data to locate and identify the expected vehicle credential information. In some cases, if the vehicle credential information matches an expected vehicle or delivery, the system may allow the vehicle 102 entry into the facility 104 (e.g., cause the gate or door to open). In some cases, the system may also scan a biometric (such as a thumb print, facial scan, eye scan, or the like) associated with a driver or operator of the vehicle 102 to determine the operator is also expected.

In some cases, upon entry into the facility 104, the vehicle 102 may proceed to the inspection area 114 to provide additional paperwork, receive additional authorizations, and to confirm contents of the vehicle 102 (e.g., assets). In this example, the driver or operator of the vehicle 102 may provide, display, or otherwise show required documents to a scanning system. In some cases, the driver may place or make visible each document and/or page, such that a scanning, sensor, and/or image system may capture data associated with the presented page. For example, the driver may hold each page up to a window of the vehicle 102 to allow for contactless scanning of the documents.

The system may also use a kiosk embedded with computer based vision and voice technologies to automate any human interaction at the entry and/or exit points 106 and 108. The kiosk-based verification system may allow a driver to verify and complete the data captured by the sensor system and request assistance in case of any exceptions. The exception management process will then guide the driver or operator using multi-lingual prompts, on the kiosk screen in a user interface and/or using NLP/NLU based autonomous voice system, such that a centralized regional or national command center may remotely assist the driver and manage any exception. Such exception management process may also be utilized when a driver arrives at a facility 104 without a pre-determined appointment.

In some cases, the kiosk-based verification system may also be used to provide a digital twin map of the yard to provide most optimal driving directions to a parking slot or region. In some cases, if a driver does not follow the instructions and parks the vehicle at a non-designated spot, the sensor system installed within the yard (e.g., a sensor system that tracks the entire yard all the time for any activity) may automatically update available open slot positions, such as at area 110, and use this near real-time data to guide the next driver check-in at the gate 106. In some cases, the captured information at check-in and check-out may be fed into a yard management or similar system to enable near real-time predictive planning of yard and dock door operations using machine learned models or techniques. This data augmentation will further improve operational efficiency and reduce the time spent by a carrier within a facility, thus minimizing or eliminating carrier surcharges, improve carrier's delivery performance, and facility operator's preferred status with carriers during contract rate negotiations. In some cases, this sensor system can also be added by transportation service providers as a required part of their contract with their customers such that they can get paid based on when their vehicle entered a customer facility and/or yard versus when it got docked at the dock door for loading and/or unloading operations, which may happen at a later time.

The system may also employ an automated aerial vehicle or other sensor system that may allow the facility to scan the contents of the vehicle or containers. In some case, the driver or operator of the vehicle 102 may assist via automated voice commands or instructions displayed on a display at the inspection area to select a package or container for opening such that the scanning, sensor, and/or image system may capture data associated with the contents (e.g., assets) of the container. In this example, the inspection area may be unitized to improve the flow of vehicles into the facility 104, however, it should be understood that the documents may be processed at the entry location and/or at an unloading area 112. For example, upon arrival at the unloading area 112, a driver may scan a bill of laden or other inventory related document which may then be processed by the system 100 prior to unloading of the vehicle. Likewise, prior to loading of the vehicle the driver or a facility operator may again scan a bill of lading or another inventory related document.

The system may then parse the captured sensor data to extract information associated with the documents, confirm the assets and a condition of the assets, accept a chain of custody for the assets, and the like. The system may also confirm the extracted data is correct and complete. If the extracted data is not, the system may attempt to obtain the correct and/or missing information from a third-party, such as a system associated with the vehicle 102, the seller, the buyer, a government agency, other facility, or the like. By obtaining the information directly from another system, the verification system, discussed herein, may reduce the overall wait time and delays caused by incorrectly completed forms and documents typical with conventional check-in systems.

Once the documents are accepted by the system, the vehicle 102 may be directed to a waiting area 110 and/or an unloading area 112. At the unloading area, the system may include additional sensor and/or image devices to track the assets as they are unloaded from the vehicle. The assets may then be assigned by the system to storage areas, repackaging areas, or other loading areas. In some cases, the system may confirm the number, type, and state (e.g., condition) of the assets as the assets are unloaded from the vehicle 102.

In some cases, after unloading the vehicle 102 may be loaded with new assets. The system may again track the number, type, and status of the assets as they are loaded onto the vehicle 102 via the data captured the sensors and/or image devices. The system may again transfer the chain of title or custody from the facility to the vehicle or an entity associated with the vehicle 102.

The vehicle 102 may then proceed to the exit or check-out area 108 in which the vehicle information may again be scanned or data captured by the sensor and/or image system. In some cases, the system may again determine the type of vehicle /d/ based on the type, determine expected vehicle information. The system may then extract the expected information to perform the vehicle check-out. The system may again collect biometric data associated with driver or operator of the vehicle 102 to again confirm the correct vehicle and operator are exiting the facility 104 and accepting a chain of title or custody for the assets.

In one specific example, the system 100 may determine at exit the identity of the vehicle with respect to multiple approaching vehicles. For instance, in some facilities 104, multiple exit lanes may be visible and/or merge at the check-out area 108. In these examples, the system 100 may utilize sensor data representative of the environmental and/or sensor data representative of the vehicle to determine the identity of the vehicle and confirm that the vehicle is the vehicle exiting the facility 104. In some cases, few additional assets may be parked or be present close to the entry 106 and/or exit gate 108, resulting in uncertainty from multiple vehicles in a sensor system's field of view. In such a case, the sensor system may use prior knowledge based on continuous tracking of each asset, vehicle, and/or container within and/or at the perimeter of the facility to accurately determine the asset that needs to be scanned during the check-in or check-out process, thus eliminating incorrect asset scans.

In some examples, the system 100, discussed herein, may be used to assist with governmental and regulatory compliance and/or audit at the check-in area 102 and/or the check-out area 108. For instance, as one illustrative example, the system 100 may be configured to ensure Federal Motor Carrier Safety Administration (FMCSA) compliance for trucks operation within the United States. In this example, the system 100 may utilize the sensor data captured at check-in area 102 and the check-out area 108, as well as the inspection area 114 to determine if the side walls of the vehicle entering or exiting the facility 104 are damaged, the bumpers are hanging, broken, and/or otherwise damaged, the mud flaps are torn, missing, or otherwise damages, the tire treads meet or exceed a depth threshold or requirement, the rear-impact guard is hanging, missing, or otherwise damaged, and the like. The system 100 may then notify an operator or repair system to any issues prior to allowing the vehicle to commence on a new delivery and, thereby, avoid financial penalties, delays, and the like.

Further, it should be understood, that the system 100 discussed herein may utilize a multi-senor (e.g., multi-camera) system at each location or area, such as areas 102, 110, 112, 114, and/or 108. The system 100 may then coordinate or temporally algin the sensor data between the multiple sensors prior to processing and/or extracting data.

In some examples, the system 100 may employ autonomous check-in, check-out, dock door operations, vehicle scheduling (e.g., scheduling loading/uploading), inspection, and the like. In some cases, the system 100 may also unitize voice based check-in/check-out authentication of the driver and the like. For example, the driver of the vehicle may speak into one or more microphone at the various areas 102, 108, 110, 112, 114, and the like of the facility 104 and/or utilize an electronic device or in vehicle microphone to provide a voice authentication to the facility 104. In some cases, the voice authentication may be verified using the sensor data (as discussed herein) as well as to confirm the driver is actually at the specified area 102, 108, 110, 112, 114, and the like.

In some examples, the system 100 may also extract data from the vehicle including carrying cargo that may include toxic, explosive, or other information.

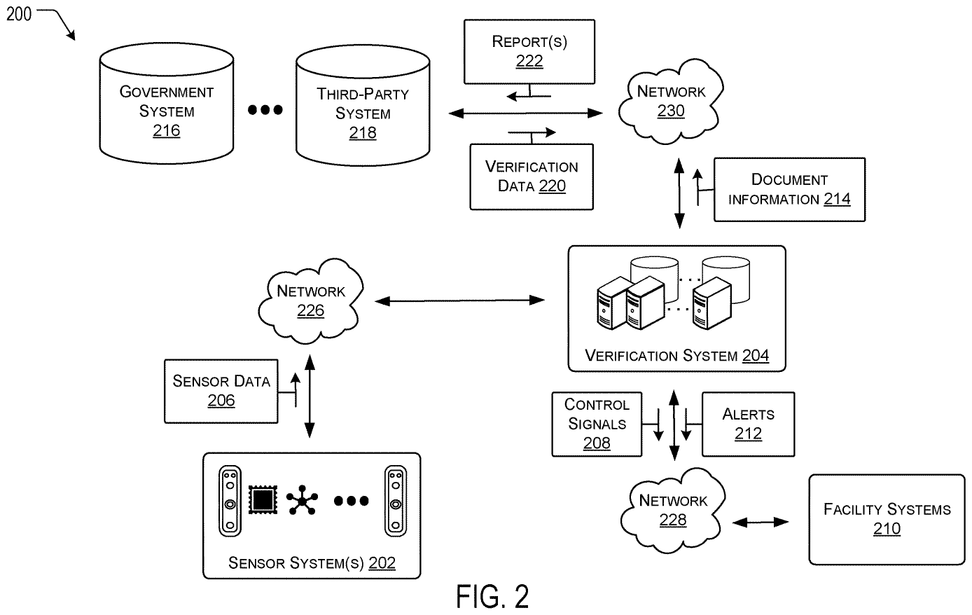

FIG. 2 is an example block diagram 200 of a verification system 204 including sensor system 202 associated with a facility for performing check in and check out, according to some implementations. For example, as a vehicle (e.g., a truck, rail car, ship, or the like) approaches an entry or exit point of the logistics facility, the sensor systems 202 may be configured to detect the vehicle and capture sensor data 206 (e.g., video, images, and the like) associated with the vehicle, one or more driver(s) of the vehicle, and/or one or more container(s), crate(s), or pallet(s) associated with the vehicle. In some cases, such as in the case of distributed fleet of vehicles, such as with independent operators, for last mile pickup and delivery, the sensor system may monitor how long an asset stayed in the yard and what was the wait time at the dock door for each vehicle, thus enabling automatic capture of dwell time surcharge calculation for an distributed fleet.

The captured sensor data 206 may then be used to determine a type of vehicle approaching. The verification system 204 may then determine expected information or credentials associated with the vehicle based at least in part on the type. For example, an incoming semitruck may include license plate numbers and jurisdiction, while an incoming cargo vessel may include craft identification numbers. In some cases, the system 204 may utilize the type of vehicle to determine a location associated with the expected vehicle credentials.

The captured sensor data 206 and/or additional sensor data 206 may be used to verify the vehicle, driver, container or contents of the container, and the like once the expected vehicle credentials are determined. The system 204 may also, upon verification of the credentials, determine if the vehicle is expected and a location to route the vehicle to (e.g., a waiting area, an inspection area, an unloading area, or the like).

In some instances, the verification system 204 may process the sensor data 206, for instance, using one or more machine learned model(s) to segment, classify, and identify the desired information (e.g., the driver's identifier, the vehicle identifier, and/or the container identifier). In some cases, each of the desired identifiers may be associated with independent heads of the machine learned model. In other examples, the processing may be performed on the IoT sensor system 102, such as NVR device or EDGE computing device.

In some examples, the sensor data 206 may also be utilized to determine a state or status of the vehicle, container, chassis, or the like. For example, the state or status may be used to determine if damage occurred during shipping and/or if any repairs to the vehicle, container, or chassis are necessary before redeployment. In some instances, additional machine learned models may be employed by the sensor system 202 and/or the cloud-based system 204 to detect damage or other wear and tear of the vehicle, container, and/or chassis. In some specific examples, the sensor systems 202 may include infrared, thermal, mmWave, XRay or other types of sensors capable of imaging or generating sensor data 206 associated with the contents of the container without opening the container. In these examples, the sensor data 206 may also be used to detect any damage caused to the contents of the containers during shipping prior to the facility accepting custody, liability, and/or responsibility for the contents. For instance, the sensor system 202 and/or the cloud-based system 204 may compare the captured sensor data 206 and/or the status output by the machine learned models to a recorded status of the vehicle, container, and/or chassis associated with the vehicle, container, and/or chassis at the time of deployment.

In the current example, the verification system 204 may be configured to, upon verification of the driver, vehicle, container, or the like, generate control signals 208 for the facility systems 210. For instance, the control signal 208 may cause a facility gate to open or a crane or other unloading/loading equipment to commence a corresponding operation (e.g., unloading or loading of goods). The verification system 204 may also generate one or more alert(s) 212 to various systems 210 or operators within the facility instructing the operators to perform various tasks or notifying the operators as to a status of the vehicle, container, or chassis. As an illustrative example, if the sensor system 202 or the cloud-based system 204 detected damage to the container, the alert 212 may instructs an operator to perform a manual inspection of the contents of the container.

In some cases, either at the entry location via sensor data 206 or at an inspection area, as discussed above, the verification system 204 may process documents associated with the vehicle, assets, and/or driver/operator. For example, the driver may hold up or otherwise present documents (e.g., bill of lading, customs forms, or the like) to a scanner and/or image capture device. The system 204 may then process the captured data to extract various document information 214.

The verification system 204 may also be configured to complete and submit various types of reports 222 associated with the vehicle, containers, and/or content of the containers at the time the vehicle enters or exits the facility as well as during inspection, loading, and/or unloading. For example, as illustrated, if the vehicle is a ship entering a port carrying goods in international trade, the verification system 204 may capture the sensor data 206 and complete, using the output of the machine learned models, various customs forms, reports 222, and/or documents using the document information 214. In some examples, the system 204 may detect labeling, identifiers, and other markers, in any language, and select appropriate government entities based on the detected information. The system 204 may then determine the appropriate government systems 216 or third-party systems 218 and document information 214 based on the selected government entities. The system 204 may then submit the documentation 214 to the corresponding systems 216 and/or 218 as required. It should be understood, that the system 204 may submit reports 222 to multiple government systems 216 and/or third-party systems 218 and receive and process verification data 220 from multiple government systems 216 and/or third-party systems 218, prior to approving the transport vehicle for entry to a facility, as discussed below.

In some example, the appropriate government systems 216 or third-party systems 218 may provide verification data 220 to the verification system 204 based on the submitted document information 214. In some cases, the verification data 220 may include authorizations and approvals associated with the vehicle or the assets associated with the vehicle, as well as any issues, alerts, or concerns associated with the vehicle or the assets. For example, the vehicle may be unauthorized (e.g., failed to maintain government licenses or the like), the assets may be restricted (such as under investigation, subject to a tariff or the like), an owner of the assets may be insolvent, or other issue may be present. In some cases, the verification system 204 may utilize the verification data 220 to determine if the vehicle is granted entry and/or the facility accepts chain of custody. In some cases, the verification data 220 may be used to determine if a government authority should be contacted with regards to the vehicle, the operator, and/or the assets. In some cases, an about to expire or expired chassis inspection certificate at entry and/or exit point may be used to alert the driver of an impending or occurred violation (such as to avoid a fine or other future fee or issue).

Once the verification system 204 has parsed or extracted the information, the assets inspected, and the documents and reports are processed, the system 204 may cause the facility to accept or deny custody of the vehicle, container, and/or contents of the container. The sensor system 202 and/or the cloud-based system 204 may also report the acceptance and/or denial of the custody to the third-party system 218, such as the shipper entity.

In the current example, the sensor data 206, documentation 214, control signals 208, alerts 212, custody notifications 224, verification data 220 and reports 222 as well as other data may be transmitted between various systems using networks, generally indicated by 226-230. The networks 226-230 may be any type of network that facilitates compunction between one or more systems and may include one or more cellular networks, radio, WiFi networks, short-range or near-field networks, infrared signals, LoRaWAN, local area networks, wide area networks, the internet, and so forth. In the current example, each network 226-230 is shown as a separate network but it should be understood that two or more of the networks may be combined or the same.

In some examples, the system 204 may receive different types of sensor data for use in tracking different types of vehicles, inventory, containers, and the like. for example, in some cases, a facility may maintain a fleet of in-house vehicles that are equipped with one or more sensor tags or identification and position tracking sensors, such as a LoRaWAN, Bluetooth Low Energy (BLE), or GPS sensors as well or in addition to utilizing a third-party fleet of third-party vehicles. In some cases, the sensors tags or identification and position tracking sensors may allow the verification system 204 to determine position and identities of the in-house fleet vehicles, drivers, and the like. Thus, the verification system 204 may track the identity, position, and/or location of the vehicles, authenticate the vehicles, drivers, operators, inventory, or the like associated with the in-house fleet using the identification and position tracking sensors tracking sensor.

In this manner, the verification and/or authentication process for the in-house fleet may be performed without requiring user input and/or consuming processing resources associated with utilizing an image based or camera based authentication, as discussed herein. In this example, the verification system 204 may still utilize the sensor systems 202 and the senor data 206 for authentication and verification of third-party fleet. In this manner, the system 204 may utilize both an image based authentication system and a tagging based authentication system.

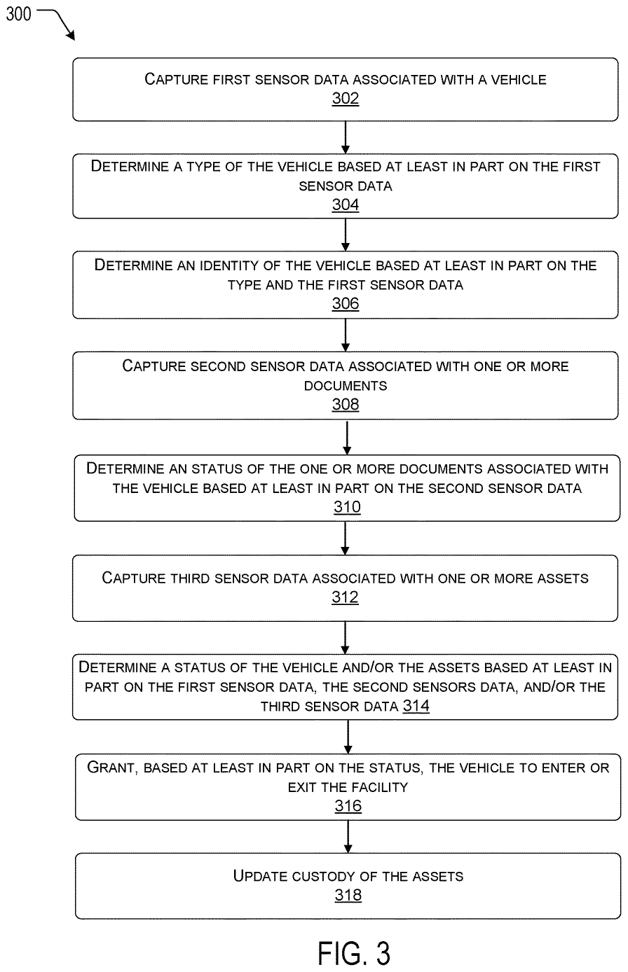

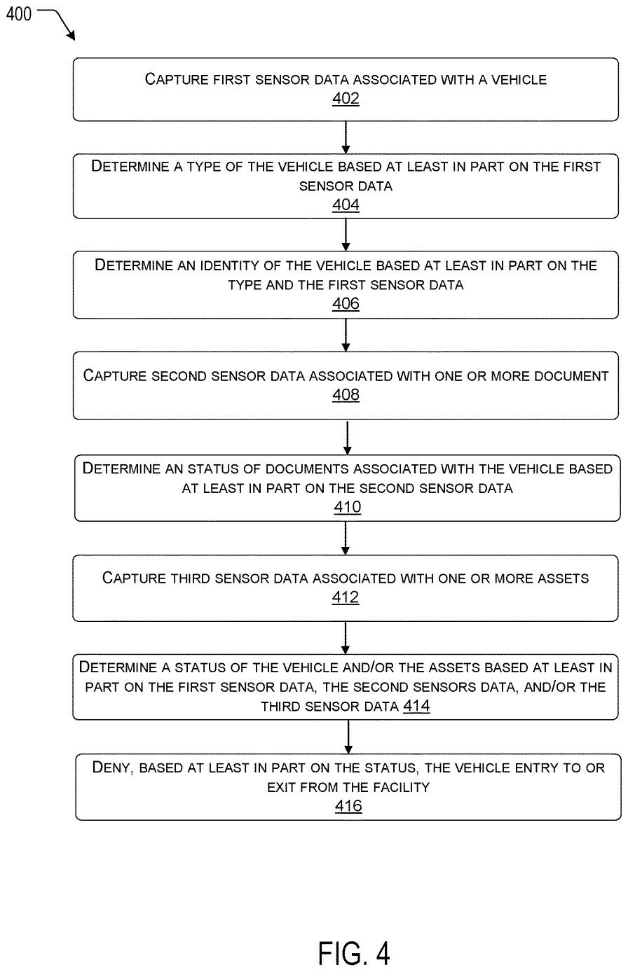

FIGS. 3 and 4 are flow diagrams illustrating example processes associated with the verification systems for checking in and out vehicles, containers, and content from a logistics or other facility discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processor(s), perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures, or environments.

FIG. 3 is a flow diagram illustrating an example process 300 associated with a verification system at a facility, according to some implementations. As discussed herein, the system may be configured to automate check-in, check-out, and chain of title or custody processes associated with entering and exiting a facility, such as a warehouse, port, rail depot, and the like. The system may include IoT, EDGE, or NVR sensors and image devices that may, in some cases, utilize cloud-based services to identify and verify vehicles, drivers, containers, as well as to capture data associated with the vehicles, drivers, containers to verify the correct parties are present as expected.

At 302, a system may first capture sensor data associated with a vehicle. For example, the vehicle may be approaching an entrance or an exit of a facility. The sensor system may capture sensor data associated with an exterior of the vehicle, an exterior of a chassis coupled to the vehicle, an exterior one or more containers associated with the vehicle. In some cases, the sensor data may include LIDAR data, SWIR data, red-green-blue image data, thermal data, Muon data, radio wave data, weight data, infrared data, and the like.

At 304, the system may determine a type of vehicle that is approaching based at least in part on the first sensor data. For instance, the system may parse the image data to detect features and the like associated with the vehicle and usable to determine a type. In some cases, the system may determine the type using one or more machine learned models and/or networks trained on vehicle data.

At 306, the system may determine an identity and/or status of the vehicle based at least in part on the type and the first sensor data. For example, using a machine learned model trained on the vehicle data and a type, the system may identify, classify, and extract vehicle credential information, such as expected credential information based on the type. Using the extracted data, the system may also verify the identity of the vehicle and/or a chassis coupled to the vehicle by, for instance, comparing with one or more records provided by a transit company, trucking company, carrier company, shipping company, and the like. In this manner, the system may determine if the delivery is arriving and/or departing on time and, if not, how late or behind the vehicle and/or facility is currently. The system may also utilize one or more machine learned models having an input as the first sensor data to detect any issues, damage, or other status related items associated with the vehicle and/or chassis.

In some examples, the system may also determine an identity of the driver of the vehicle. For example, the system may perform facial recognition on the first sensor data representative of the driver. The system may determine an identity of one or more containers (if present) associated with the vehicle based at least in part on the first sensor data.

At 308, the system may capture second sensor data associated with a vehicle. For example, the vehicle may stop at a check-point (e.g., entry or exit of the facility or an inspection area) and present documents for scanning. The system may capture sensor data associated with the displayed documentation (such as paperwork displayed via one or more of the windows of the vehicle), an interior or content of the containers or vehicle, and the like.

At 310, the system may determine a status of the one or more documents associated with the vehicle based at least in part on the second sensor data. For example, the system may extract key value pairs from the document, translate content to one or more languages, determine if expected information is missing, and the like. In some cases, the system may send the extracted information to one or more third-party systems for verification. In this example, the status may include complete, accepted, denied, incomplete, or the like.

In some implementations, the system may determine multiple status, such as a status for each of the one or more documents. In some cases, each document may be associated with a different third-party and/or government system (e.g., agency or authority). In these cases, the system may have verification data associated with each document and/or each entity, which may be used to determine the status of each document.

At 312, a system may capture third sensor data associated with a vehicle. For example, the system may capture sensor data associated an interior of the vehicle and/or content of the containers, and the like.

At 314, the system may determine a status of the vehicle and/or the one or more assets based at least in part on the first sensor data, the second sensor data, and/or the third sensor data. For example, the system may utilize one or more machine learned models to detect damage associated with the vehicle, the chassis, individual containers, and the like. In some cases, the system may determine damage based on prior stored records or sensor data associated with the corresponding vehicle, chassis, or container. For instance, the system may determine an increase in rust at a particular location of the container, one or more new dents, scratches, holes, and other impact related damage, and the like. In some cases, in response to detecting new or increased damage, the system may notify or alert a facility operator to the damage prior to the facility accepting delivery and/or custody of the contents of the container. The system may also compare the detected damage to one or more damage thresholds to determine if the newly detected damage warrants the attention of a facility operator. For example, a dent having a greater area than a damage area threshold (e.g., 2 square inches, 4 square inches, 10 square inches, and the like) may trigger an alert for a facility operator.

In some examples, the system may utilize a first machine learned model to determine the identity of the vehicle and/or chassis, a second machine learned model to determine the status of the vehicle and/or chassis, a third machine learned model to determine the status of the documents, and a fourth machine learned model to determine the status of the assets. In other examples, the machine learned models may be combined such as multiple heads or outputs of a neural network. In some cases, the sensor data input into each model may be the same types of sensor or image data, however, in other examples, the types of input data may vary. For example, the sensors may include thermal sensors, time-of-flight sensors, location sensors, LIDAR sensors, SIWIR sensors, radar sensors, sonar sensors, infrared sensors, cameras (e.g., RGB, IR, intensity, depth, and the like), Muon sensors, microphone sensors, environmental sensors (e.g., temperature sensors, humidity sensors, light sensors, pressure sensors, etc.), and the like. In some examples, the sensor may include multiple instances of each type of sensors. For instance, camera sensors may include multiple cameras disposed at various locations. The system may also include one or more emitter(s) for emitting light and/or sound. By way of example and not limitation, the emitters in this example include light, illuminators, lasers, patterns, such as an array of light, audio emitters, and the like.

As an example, the system may use sonar sensors and infrared sensors to capture sensor data for determining the status of the assets and image data to determine the status and/or identity of the vehicle and/or chassis. In one example, the system may use Meun, infrared, LIDAR, SIWIR, or thermal sensors to generate the input sensor data when the environment is dark, snowing, raining, or other whether condition that may affect image data. In this manner, the system may select the type of sensor data input into the machine learned models of or otherwise processed by 304-314.

At 316, the system may grant, based at least in part on the status, the vehicle to enter or exit the facility and, at 318, the system may update the custody of the assets. For example, if the vehicle, driver, and containers passed the verification and there is no damage or concerns detected with the status of the vehicle, containers, or content of the containers, the system may send a control signal to lift a gate and to allow the vehicle to enter and/or exit the facility. In some cases, the vehicle may be instructed by the system to proceed to the secondary check-in area for additional verification (such as manual or human verification, internal inspection of inventory or assets, and the like), a designated loading/unloading area, a waiting area (such as a temporary waiting area), a yard parking area in which the trailer or vehicle may delivered for longer term storage, or the like.

In some cases, the system may grant entry based on a verification data for each document from each responsible entity (e.g., originating government body, receiving government body, originating facility, transport authorities, transport entity, and the like). In these cases, the status for each document may be based on the verification data, such as a pass or fail, for each document. The system may then grant entry when the status of each document indicates a pass according to the corresponding verification data.

FIG. 4 is a flow diagram illustrating an example process 400 associated with a verification system at a facility, according to some implementations. As discussed herein, the system may be configured to automate check-in, check-out, and chain of title or custody processes associated with entering and exiting a facility, such as a warehouse, port, rail depot, and the like. The system may include IoT, EDGE, or NVR sensors and image devices that may, in some cases, utilize cloud-based services to identify and verify vehicles, drivers, containers, as well as to capture data associated with the vehicles, drivers, containers to verify the correct parties are present as expected. In some cases, a real-time satellite image data of the facility or satellite tracking of an asset may be used to complement the data being captured at the automated entry gates and/or exit gates.

At 402, a system may first capture sensor data associated with a vehicle. For example, the vehicle may be approaching an entrance or an exit of a facility. The sensor system may capture sensor data associated with an exterior of the vehicle, an exterior of a chassis coupled to the vehicle, an exterior one or more containers associated with the vehicle. In some cases, the sensor data may include LIDAR data, SWIR data, red-green-blue image data, thermal data, Muon data, radio wave data, weight data, infrared data, and the like.

At 404, the system may determine a type of vehicle that is approaching based at least in part on the first sensor data. For instance, the system may parse the image data to detect features and the like associated with the vehicle and usable to determine a type. In some cases, the system may determine the type using one or more machine learned models and/or networks trained on vehicle data.

At 406, the system may determine an identity of the vehicle based at least in part on the type and the first sensor data. For example, using a machine learned model trained on the vehicle data and a type, the system may identify, classify, and extract vehicle credential information, such as expected credential information based on the type. Using the extracted data, the system may also verify the identity of the vehicle and/or a chassis coupled to the vehicle by, for instance, comparing with one or more records provided by a transit company, trucking company, carrier company, shipping company, and the like. In this manner, the system may determine if the delivery is arriving and/or departing on time and, if not, how late or behind the vehicle and/or facility is currently.

In some examples, the system may also determine an identity of the driver of the vehicle. For example, the system may perform facial recognition on the first sensor data representative of the driver. The system may determine an identity of one or more containers (if present) associated with the vehicle based at least in part on the first sensor data.

At 408, the system may capture second sensor data associated with a vehicle. For example, the vehicle may stop at a check-point (e.g., entry or exit of the facility or an inspection area) and present documents for scanning. The system may capture sensor data associated with the displayed documentation (such as paperwork displayed via one or more of the windows of the vehicle), an interior or content of the containers or vehicle, and the like.

At 410, the system may determine a status of the documents associated with the vehicle based at least in part on the second sensor data. For example, the system may extract key value pairs from the document, translate content to one or more languages, determine if expected information is missing, and the like. In some cases, the system may send the extracted information to one or more third-party systems for verification. In this example, the status may include complete, accepted, denied, incomplete, or the like.

At 412, a system may capture third sensor data associated with a vehicle. For example, the system may capture sensor data associated an interior of the vehicle and/or content of the containers, and the like.

At 414, the system may determine a status of the vehicle and/or the one or more assets based at least in part on the first sensor data, the second sensor data, and/or the third sensor data. For example, the system may utilize one or more machine learned models to detect damage associated with the vehicle, the chassis, individual containers, and the like. In some cases, the system may determine damage based on prior stored records or sensor data associated with the corresponding vehicle, chassis, or container. For instance, the system may determine an increase in rust at a particular location of the container, one or more new dents, scratches, holes, and other impact related damage, and the like. In some cases, in response to detecting new or increased damage, the system may notify or alert a facility operator to the damage prior to the facility accepting delivery and/or custody of the contents of the container. The system may also compare the detected damage to one or more damage thresholds to determine if the newly detected damage warrants the attention of a facility operator. For example, a dent having a greater area than a damage area threshold (e.g., 2 square inches, 4 square inches, 10 square inches, and the like) may trigger an alert for a facility operator. In some cases, damage detection of an asset or portions or parts of the asset could be performed using machine or computer vision techniques and/or using a three-dimensional point clouds using various sensors such as LIDAR, mmWave, and the like.

As discussed above, the system may utilize multiple machine learned models to determine the identity of the vehicle and/or chassis, the status of the vehicle and/or chassis, the status of the documents, and/or the status of the assets. Also as discussed above, the system may utilize different types of sensor data as input the machine learned models and/or the processing associated with 404-414.

At 416, the system may deny, based at least in part on the status, the vehicle to enter or exit the facility. For example, if the vehicle, driver, and containers failed the verification or there is damage or other concerns detected with the status of the vehicle, containers, or content of the containers, the system may send a control signal to an electronic device associated with a display and the gate indicating that the vehicle has been denied entry and that acceptance of the assets is rejected. In some cases, the system may direct the vehicle to an area of human or manual inspection prior to accepting the chain of custody of the assets rather than denying entry.

In some cases, the system may deny entry based on a verification data for each document from each responsible entity (e.g., originating government body, receiving government body, originating facility, transport authorities, transport entity, and the like). In these cases, the status for each document may be based on the verification data, such as a pass or fail, for each document. The system may then deny entry when the status of a single document indicates a fail according to the corresponding verification data. In other cases, the system may grant entry but direct the transport vehicle to secondary check-in area for further verification and authentication.

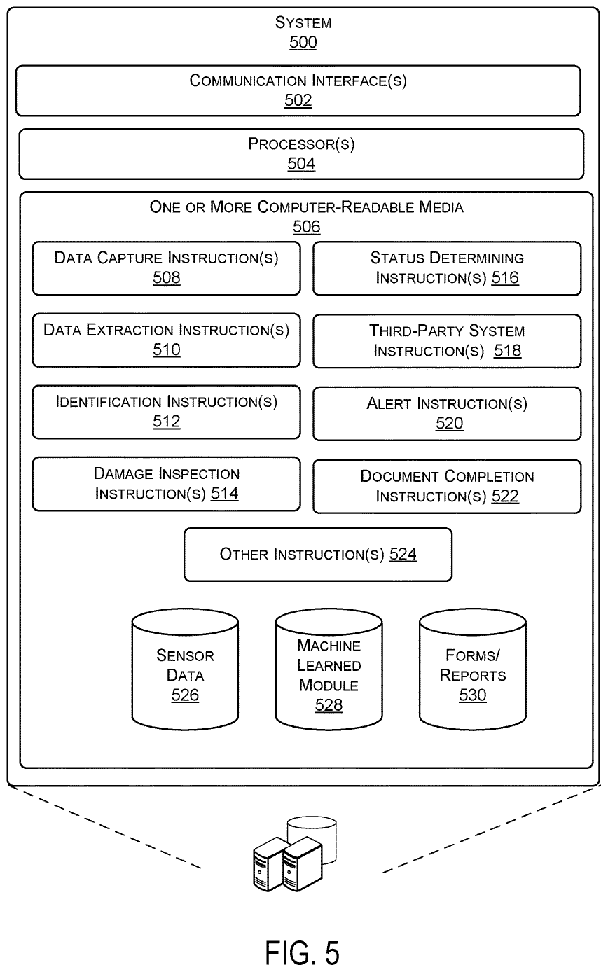

FIG. 5 is an example system 500 that may implement the techniques described herein according to some implementations. The system 500 may include one or more communication interface(s) 502 (also referred to as communication devices and/or modems), one or more processor(s) 504, and one or more computer readable media 506.

The system 500 can include one or more communication interfaces(s) 502 that enable communication between the system 500 and one or more other local or remote computing device(s) or remote services, such as a sensor system of FIG. 2. For instance, the communication interface(s) 502 can facilitate communication with other central processing systems, a sensor system, or other facility systems. The communications interfaces(s) 502 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The system 500 may include one or more processors 504 and one or more computer-readable media 506. Each of the processors 504 may itself comprise one or more processors or processing cores. The computer-readable media 506 is illustrated as including memory/storage. The computer-readable media 506 may include volatile media (such as random access memory (RAM)) and/or nonvolatile media (such as read only memory (ROM), Flash memory, optical disks, magnetic disks, and so forth). The computer-readable media 506 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Several modules such as instructions, data stores, and so forth may be stored within the computer-readable media 506 and configured to execute on the processors 504. For example, as illustrated, the computer-readable media 506 stores data capture instructions 508, data extraction instructions 510, identification instructions 512, damage inspection instructions 514, status determining instructions 516, third-party system instruction 518, alert instructions 520, document completion instructions 522, as well as other instructions 524, such as an operating system. The computer-readable media 506 may also be configured to store data, such as sensor data 526, machine learned models 528, forms and reports 530, as well as other data.

The data capture instructions 508 may be configured to utilize or activate sensor and/or image capture devices to capture data associated with the vehicle, driver, operator, container, package, chassis, or other system or vessel related to a storage facility. In some cases, the data capture instructions 508 may select between individual sensor systems based on a current weather, visibility, light, time of day, time of year, physical location, type and/or size of vehicle, type and/or size of container, number of containers, and the like. In some cases, an asset (e.g., a trailer or a container) may be scanned for damages and an insurance estimate generated for maintenance and repair operations along with industry standard codes.

The data extraction instructions 510 may be configured to input the captured sensor data 526 into one or more machine learned models 528 to generate and/or extract text and data associated with the inventory, vehicle, container, and/or content of the containers. The data may be extracted from the exterior or interior of the inventory, vehicle, or containers, documents associated with the inventory, vehicle, or containers, and the like.

The identification instructions 512 may be configured to determine an identity of the inventory, vehicle, container, or content of the containers, a chassis associated with the inventory, vehicle, a driver or operator of the vehicle, an entity associated with the inventory, vehicle, container, or content of the containers. For example, the identification instructions 512 may utilize one or more machine learned models 528 with respect to the sensor data 526 to determine the identification as discussed above.

The damage inspection instructions 514 may be configured to input the captured sensor data 526 into one or more machine learned models 528 to detect damage with respect to the inventory, vehicle, the chassis, the containers, and/or the content of the containers. For example, the damage inspection instructions 514 may detect damage using the machine learned models then compare the damage detected with any known damage to determine if the damage was received while the inventory or the vehicle was in transit. In some cases, the damage inspection instructions 514 be configured to input the captured sensor data 526 into one or more machine learned models 528 to detect damage with respect to deterioration or corrosion of inventory, rodent or insect infestations, or the like. In some cases, the damage inspection instructions 514 may also rate the damage, for instance, using a severity rating.

The status determining instructions 516 may be configured to input the captured sensor data 526 into one or more machine learned models 528 to determine a status with respect to the asset, vehicle, the driver, the documentation, the chassis, the containers, and/or the content of the containers. In some cases, the status determining instructions 516 may be configured to input the captured sensor data 526 into one or more machine learned models 528 to determine an age or quality of asset or vehicle.

The third-party system instructions 518 may be configured to select and/or identify various entities and associated documentation that is required, associated with the inventory, vehicle, container, or content of the container and/or should otherwise be completed by the document completion instructions 522. For example, the third-party system instructions 518 may select the entities and/or documents to provide to or request data from.

The alert instructions 520 may be configured to alert or otherwise notify a facility operator and/or facility system in response to the data generated by the data extraction instructions 510, the identification instructions 512, the damage inspection instructions 514, the status determining instructions 516, and/or a combination thereof. For example, the alert instructions 520 may open a gate, request manual inspection of an inventory item, request manual inspection of the contents of the container or review of a document, send an alert that the inventory count has dropped below a threshold value, send an alert that inventory item has experienced physical damage, send an alert that a position of an item (e.g., the inventory item) is associated with a safety issue, and the like.

The document completion instructions 522 may be configured to complete the documents with data received from the sensor data and/or third-party systems 518. The document completion instructions 522 may also transmit or submit the completed documents to the appropriate third-party systems on behalf of the facility, driver, or the like.

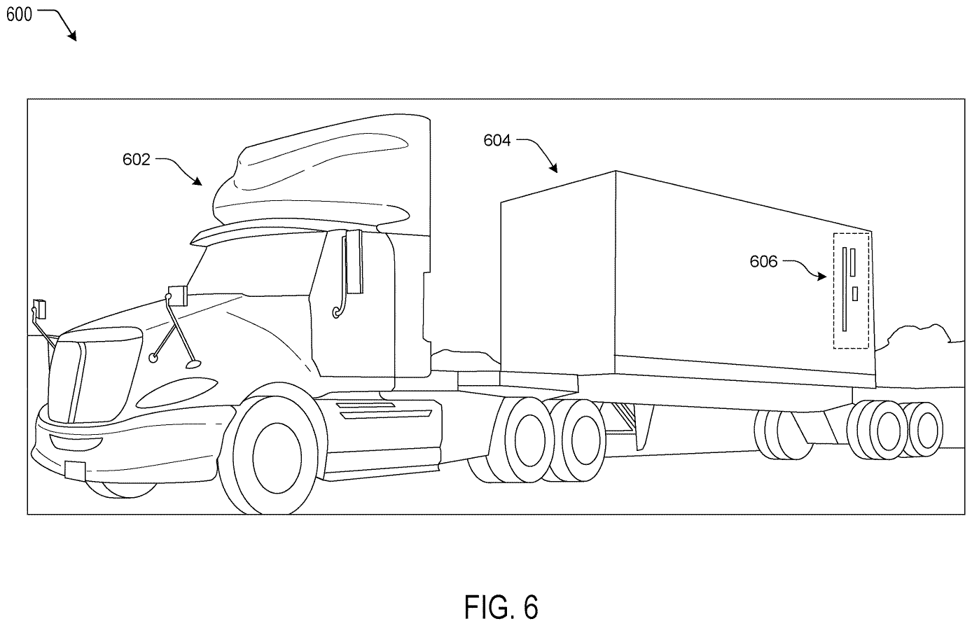

FIGS. 6-9 illustrate other example pictorial views associated with the systems of FIGS. 1-5 according to some implementations. In these examples, the system may extract various data, as illustrated, from the various example vehicles in the manner discussed here.

FIG. 6 is an example pictorial view 600 associated with the systems of FIGS. 1-5 according to some implementations. In the current example, a vehicle 602 is transporting a container 604. The container 604 includes identification data 606 that may be extracted by the systems discussed herein, as illustrated. For instance, the sensor or image system may capture the image of the vehicle 602 and the container 604. The image may be processed, such as via one or more machine learned models trained using container and vehicle image data, to detect and extract the indemnification data 606 from the side of the container 704, as shown.

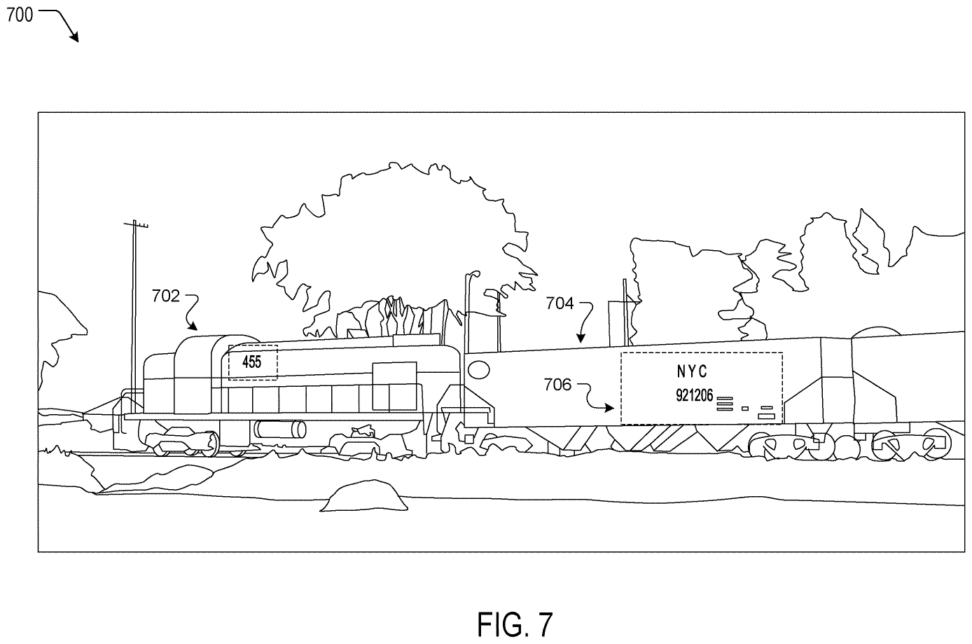

FIG. 7 is another example pictorial view 700 associated with the systems of FIGS. 1-5 according to some implementations. In the current example, a vehicle 702 (e.g., the train) is transporting multiple containers, including container 704. The container 704 includes identification data 706 that may be extracted by the systems discussed herein, as illustrated. For instance, the sensor or image system may capture the image of the vehicle 702 and the container 704. The image may be processed, such as via one or more machine learned models trained using container and vehicle image data, to detect and extract the indemnification data 706 from the side of the container 804, as shown.

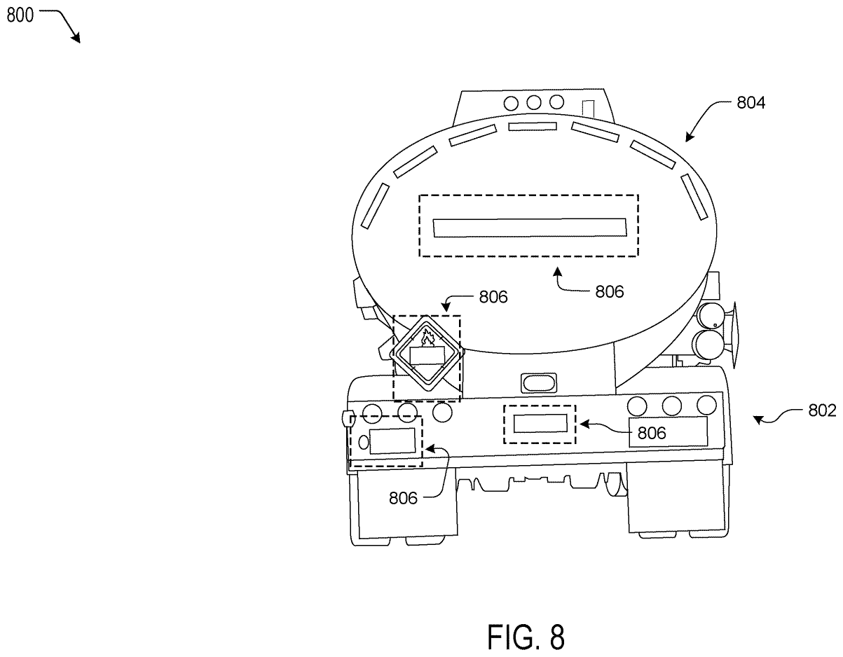

FIG. 8 is another example pictorial view 800 associated with the systems of FIGS. 1-5 according to some implementations. In the current example, a vehicle 802 is transporting a container 804 (e.g., a liquids container). The container 804 includes multiple areas that display identification data 806 that may be extracted by the systems discussed herein, as illustrated. For instance, the sensor or image system may capture the image of the vehicle 802 and the container 804. The image may be processed, such as via one or more machine learned models trained using container and vehicle image data, to detect each area containing identification data 606 and extract the indemnification data 806, as shown.

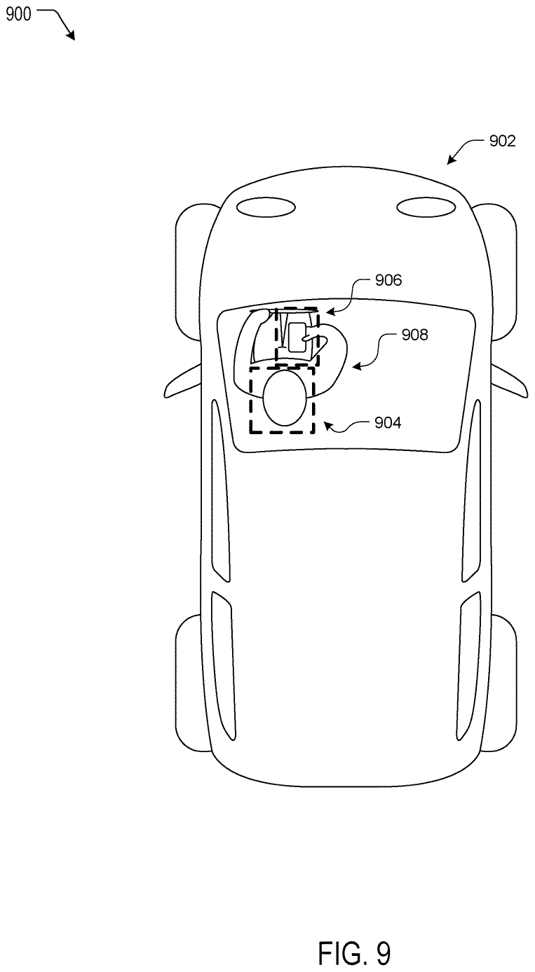

FIG. 9 is an example diagram 900 associated with the systems of FIGS. 1-5 according to some implementations. In the current example, a vehicle 902 is transporting assets into a facility. In this example, an overhead sensor or image device of the system may capture biometric data 904 (e.g., facial identification data) associated with an operator 908 and identification data 906 from a device or paper presented by the operator 908 of the vehicle 902. For instance, the sensor or image system may capture the image of the vehicle 902 and the operator 908. The image may be processed, such as via one or more machine learned models trained using container and vehicle image data, to detect and extract the biometric data 906 and the indemnification data 906, as shown. In the current example an overhead view of the vehicle 902 is captured, however, it should be understood that multiple views or alternative views may be used as an input to detect and extract the biometric data 906 and the indemnification data 906.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

### EXAMPLE CLAUSES

A. A method comprising: detecting a vehicle at an entry location of a facility based at least in part on first sensor data associated with the entry location; determining, based at least in part on the first sensor data, an identity of the vehicle; determining, based at least in part on second sensor data associated with a document presented at the entry location, a status of the document; determining, based at least in part on third sensor data associated with an asset associated with the vehicle, a status of the asset; and granting, based at least in part on the identity of the vehicle, the status of the document, and the status of the asset, entry to the facility.

B. The method of A, further comprising: determining, based at least in part on the first sensor data, a status of the vehicle; and wherein granting entry to the facility is based at least in part on the status of the vehicle.

C. The method of any of A or B, further comprising: responsive to granting entry to the vehicle, updating a chain of custody associated with the asset to indicate custody by the facility or an entity associated with the facility.

D. The method of any of A-C, further comprising: receiving verification data from a third party system; and wherein granting entry to the facility is based at least in part on the verification data.

E. The method of any of A-D, wherein granting entry to the facility further comprises sending a control signal to operate a gate associated with the entry location.

F. The method of any of A-E, wherein determining the identity of the vehicle further comprise inputting the first sensor data into one or more machine learned models, the one or more machine learned models trained on image data of vehicles and receiving as an output of the one or more machine learned models the identity of the vehicle.

G. The method of any of A-F, further comprising directing the vehicle to at least one of an unloading area or a waiting area.

H. The method of any of A-G, further comprising determining, based at least in part on the status of the assets, the identity of the vehicle, the verification data, or status of the document, to direct the vehicle to the secondary check-in area.

I. The method of any of any of A-H, further comprising presenting instructions on a display associated with the entry location, the instructions including direction to at least one of an unloading area, a waiting area, a trial delivery area, or a secondary check-in area.

J. The method of any of A-I, further comprising: detecting the vehicle at an exit location of the facility based at least in part on fourth sensor data associated with the exit location; confirming, based at least in part on the fourth sensor data, the identity of the vehicle; determining, based at least in part on fifth sensor data associated with an additional asset associated with the vehicle, a second status of the additional asset; and granting, based at least in part on the identity of the vehicle and the status of the additional asset, exit from the facility.

J. The method of J, further comprising responsive to granting exit from the facility to the vehicle, updating a chain of custody associated with the additional asset.

K. A computer program product comprising coded instructions that, when run on a computer, implement a method as claimed in any of A-J.

L. A system comprising: one or more sensors; one or more processors; and one or more non-transitory computer readable media storing instructions executable by the one or more processors, wherein the instructions, when executed, cause the one or more processors to perform operations comprising: detecting a vehicle at an entry location of a facility based at least in part on first sensor data associated with the entry location; determining, based at least in part on the first sensor data, a status of the vehicle; determining, based at least in part on second sensor data associated with a document presented at the entry location, a status of the document; determining, based at least in part on third sensor data associated with an asset associated with the vehicle, a status of the asset; and granting, based at least in part on the status of the vehicle, the status of the document, or the status of the asset, entry to the facility.

M. The system of L, wherein the one or more sensors including one or more image devices.

N. The system of any of L or M, wherein granting, based at least in part on the status of the vehicle, the status of the document, or the status of the asset, entry to the facility.

While the example clauses described above are described with respect to one particular implementation, it should be understood that, in the context of this document, the content of the example clauses can also be implemented via a method, device, system, a computer-readable medium, and/or another implementation. Additionally, any of examples may be implemented alone or in combination with any other one or more of the other examples.

What is claimed is:

1. A method for automating vehicle check-in at a facility, comprising:
receiving sensor data associated with a vehicle from one or more image devices at an entry location of the facility;
processing the sensor data with a verification system, wherein processing comprises:
with one or more machine learned models, determining one or more properties associated with the vehicle including a type and an identity of the vehicle;
receiving input data based on an interaction between an operator of the vehicle and an input terminal;
processing the input data with the verification system by:
generating a check-in event for the vehicle;
validating, with the one or more machine learned models, the check-in event based at least in part on the one or more properties associated with the vehicle;
determining a destination within the facility for the vehicle based on the validated check-in event; and
generating guidance data comprising path guidance from the entry location to the determined destination, the guidance data causing display of visual elements indicating the destination.

2. The method of claim 1, wherein the input terminal is at the entry location and in communication with the verification system.

3. The method of claim 1, further comprising:
generating, with the one or more machine learned models, a three-dimensional model of the vehicle based at least in part on the sensor data;
receiving second sensor data associated with the vehicle from the one or more image devices at an exit location of the facility;
generating, with the one or more machine learned models, a second three-dimensional model of the vehicle based at least in part on the second sensor data; and
determining, based at least in part on a comparison of the three-dimensional model and the second three-dimensional model, damage to the vehicle incurred during a duration between the sensor data captured at the entry location and the second sensor data captured at the exit location.

4. The method of claim 1, wherein the guidance data comprises generated visual elements that overlay onto a map of the facility.

5. The method of claim 4, wherein the map of the facility is a digital twin of the facility.

6. The method of claim 1, wherein the input data comprises an image of identification of the operator, the method further comprising:
determining, with the one or more machine learned models, one or more properties of the identification from the image; and
wherein validating the check-in event is based at least in part on the determined one or more properties of the identification.

7. The method of claim 1, further comprising, with an interface of the verification system, retrieving existing information related to the vehicle or the operator from a yard management system.

8. A system for automating vehicle check-in at a facility, the system comprising:
one or more image devices;
one or more processors; and
one or more non-transitory computer readable media storing instructions executable by the one or more processors, wherein the instructions, when executed, cause the one or more processors to perform operations comprising:
receiving sensor data associated with a vehicle from the one or more image devices associated with the facility;
processing the sensor data with a verification system, wherein processing comprises:
determining, with one or more machine learned models, one or more properties associated with the vehicle including a type and an identity of the vehicle;
receiving input data based on an interaction between an operator of the vehicle and an input terminal in communication with the verification system;
validating, based at least in part on the one or more properties associated with the vehicle, a check-in of the vehicle;
determining a destination within the facility for the vehicle; and
generating direction data comprising guidance from an entry location to the determined destination, the direction data including visual elements indicating the destination.

9. The system of claim 8, wherein the operations further comprise in response to validating the check-in of the vehicle, sending a control signal to operate a gate associated with the entry location to permit entry to the vehicle.

10. The system of claim 8, wherein the operations further comprise determining, based at least in part on the sensor data, damage associated with the vehicle.

11. The system of claim 8, wherein the direction data comprises generated visual elements that overlay onto a digital twin map of the facility.

12. The system of claim 8, wherein the operations further comprise determining, based at least in part on the sensor data, an identity of the operator.

13. The system of claim 8, wherein the operations further comprise:
generating, with the one or more machine learned models, a three-dimensional model of the vehicle based at least in part on the sensor data; and
determining, based at least in part on the three-dimensional model of the vehicle, one or more properties associated with the vehicle.

14. One or more non-transitory computer readable media storing instructions executable by one or more processors, wherein the instructions, when executed, cause the one or more processors to perform operations comprising:
receiving sensor data associated with a vehicle from one or more image devices at an entry location of a facility;
processing the sensor data with a verification system, wherein processing comprises:
determining, with one or more machine learned models, one or more properties associated with the vehicle including a type and an identity of the vehicle;
receiving input data based on an interaction between an operator of the vehicle and an input terminal;
processing the input data with the verification system by:
generating a check-in event for the vehicle;
validating the check-in event based at least in part on the one or more properties associated with the vehicle;
determining, based on the validated check-in event, a destination within the facility for the vehicle; and
generating guidance data comprising path guidance from the entry location to the determined destination, the guidance data causing display of visual elements indicating the destination.

15. The one or more non-transitory computer readable media of claim 14, wherein the input terminal is at the entry location and in communication with the verification system.

16. The one or more non-transitory computer readable media of claim 14, wherein the operations further comprise:
generating a three-dimensional model of the vehicle based at least in part on the sensor data;
receiving second sensor data associated with the vehicle from the one or more image devices at an exit location of the facility;
generating a second three-dimensional model of the vehicle based at least in part on the second sensor data; and
determining damage to the vehicle incurred during a duration between the sensor data captured at the entry location and the second sensor data captured at the exit location based at least in part on a comparison of the three-dimensional model and the second three-dimensional model.

17. The one or more non-transitory computer readable media of claim 14, wherein the guidance data comprises generated visual elements that overlay onto a map of the facility.

18. The one or more non-transitory computer readable media of claim 17, wherein the map of the facility is a digital twin of the facility.

19. The one or more non-transitory computer readable media of claim 14, wherein the input data comprises an image of identification of the operator, and wherein the operations further comprise:
determining one or more properties of the identification from the image; and
wherein validating the check-in event is based at least in part on the determined one or more properties of the identification.

20. The one or more non-transitory computer readable media of claim 14, wherein the operations further comprise retrieving existing information related to the vehicle or the operator from a yard management system.

21. The one or more non-transitory computer readable media of claim 20, wherein the existing information comprises at least one of:
an expected delivery time associated with the vehicle;
an expected driver associated with the vehicle;
an expected asset associated with the vehicle;
an available parking slot within the facility; or
an appointment associated with the facility.

22. The one or more non-transitory computer readable media of claim 20, wherein:
the existing information includes expected vehicle credential information; and
the operations further comprise:
comparing sensor data to the expected vehicle credential information associated with the vehicle;
determining, based at least in part on an output of the comparison, that the operator is an expected driver and the vehicle is an expected vehicle; and
in response to determining that the operator is the expected driver and the vehicle is the expected vehicle, directing the vehicle to desired area of the facility.

23. The one or more non-transitory computer readable media of claim 14, wherein the operations further comprise:
receiving exit sensor data associated with the vehicle from one or more exit image devices at an exit location of the facility;
determine, with the one or more machine learned models and based at least in part on the exit sensor data, a tire tread depth associated with one or more tires of the vehicle; and
generating a tire safety alert in response to the tire tread depth being below a tire tread threshold; and
preventing, based at least in part on the tire tread depth and via a physical gate of the facility, the vehicle from exiting the facility.

24. A method for detecting vehicle damage at a facility, comprising:
receiving, from one or more image devices at an entry location of the facility, sensor data associated with a vehicle approaching the entry location;
generating, with one or more machine learned models, a three-dimensional model of the vehicle based at least in part on the sensor data;
analyzing, with the one or more machine learned models, the three-dimensional model to detect damage associated with the vehicle; and
generating an alert in response to the damage exceeds a damage threshold.

25. The method of claim 24, further comprising:
processing the sensor data with a verification system to determine one or more properties associated with the vehicle;
validating, based at least in part on the one or more properties associated with the vehicle, entry of the vehicle to the facility; and
in response to validating entry of the vehicle and determining that the damage does not exceed the damage threshold, sending a control signal to actuate a gate associated with the entry location to permit entry to the vehicle.

26. The method of claim 24, further comprising in response to detecting the damage, transmitting an alert to at least one of a third-party system, a facility system, an operator, a manager, an insurance carrier, or a government agency.

27. The method of claim 24, further comprising time stamping the detection of the damage and comparing the sensor data with data collected at an originating facility to determine at least one of a time of the damage or a responsible party for the damage.

28. The method of claim 24, further comprising estimating, with the one or more machine learned models, damage to assets contained within a container associated with the vehicle based at least in part on the detected damage to the vehicle.

29. The method of claim 24, further comprising determining, based at least in part on the detected damage, whether repairs to the vehicle, a container associated with the vehicle, or a chassis associated with the vehicle are necessary.

30. The method of claim 24, wherein the one or more image devices include at least one of an infrared sensor, a thermal sensor, an mmWave sensor, or an XRay sensor.
